(19) United States
(12) Patent Application Publication
(10) Pub. No.: US 2012/0322489 A1
(43) Pub. Date: Dec. 20, 2012

(54) APPARATUS AND METHOD FOR IDLE-STATE SIGNALING REDUCTION CONTROL IN WIRELESS NETWORKS

(76) Inventors: Jennifer Liu, Plano, TX (US); Nicolas P. Drevon, Paris (FR); Bruno Landais, Pleumeur-Bodou (FR)

(21) Appl. No.: 13/494,096

(22) Filed: Jun. 12, 2012

Related U.S. Application Data
(60) Provisional application No. 61/497,408, filed on Jun. 15, 2011.
(60) Provisional application No. 61/498,128, filed on Jun. 17, 2011.

(51) Int. Cl. H04W 72/04

(52) U.S. Cl. 455/514

(57) ABSTRACT

A network-side Idle-State Signaling Reduction (ISR) control capability is presented. The network-side ISR control capability supports network-side ISR handling under various conditions. The network-side ISR handling may be provided by supporting an ISR status for a User Equipment (UE) on a network node and controlling modification of the ISR status for the UE on the network node under various conditions. The control over modification of the ISR status for the UE on the network node may include maintaining the state of the ISR status for the UE on the network node in its current state when a condition associated with the UE is detected. The condition may be a deactivation of a context of the UE, a modification of a context of the UE, a switching of an access mode of the UE, or the like.

### CROSS REFERENCE TO RELATED APPLICATION

This application claims the benefit of U.S. Provisional Patent Application Ser. No. 61/498,128, filed Jun. 17, 2011, which is hereby incorporated herein by reference in its entirety.

### TECHNICAL FIELD

The invention relates generally to wireless communications and, more specifically but not exclusively, to controlling Idle-State Signaling Reduction (ISR) in wireless networks.

### BACKGROUND

The Evolved-Universal Mobile Telecommunications System (UMTS) Terrestrial Radio Access Network (E-UTRAN) is being developed as an intended replacement for earlier generation networks such as the UMTS Terrestrial Radio Access Network (UTRAN) and the Global System for Mobile Communications (GSM) EDGE Radio Access Network (GERAN). The initial deployment of E-UTRAN is expected to be focused on densely-populated metropolitan areas and, thus, the initial availability of E-UTRAN coverage may be limited. This limited availability of E-UTRAN coverage may cause a User Equipment (UE) to perform Radio Access Network (RAN) reselection relatively frequently in order maintain radio coverage (e.g., reselecting between the E-UTRAN and GERAN/UTRAN networks). This type of RAN reselection by a UE triggers Tracking Area Update (TAU)/Routing Area Update (RAU) procedures and, thus, causes an associated increase in network signaling load.

Idle-State Signaling Reduction (ISR) is a feature being introduced in conjunction with E-UTRAN in order to reduce the frequency of TAU/RAU procedures caused when a UE reselects between the E-UTRAN network and the GERAN/UTRAN networks. ISR addresses this issue by allowing dual registration from a UE simultaneously on both the E-UTRAN network and the GERAN/UTRAN network, thereby allowing the UE, while in an idle state, to reselect between the E-UTRAN network and the GERAN/UTRAN network without performing TAU or RAU procedures.

### SUMMARY

Various deficiencies in the prior art are addressed by embodiments for controlling Idle-State Signaling Reduction (ISR) for User Equipment (UE) in wireless networks.

In one embodiment, an apparatus includes a processor and a memory communicatively connected to the processor, where the processor is configured to maintain an ISR status for a UE on a network node in an active state when a condition associated with the UE is detected.

In one embodiment, a network node includes a processor and a memory communicatively connected to the processor, where the processor is configured to maintain an ISR status for a UE on the network node in an active state when a condition associated with the UE is detected.

In one embodiment, a computer-readable storage medium stores instructions which, when executed by a computer, cause the computer to perform a method including a step of maintaining an ISR status for a UE on a network node in an active state when a condition associated with the UE is detected.

In one embodiment, a method includes a step of maintaining an ISR status for a UE on a network node in an active state when a condition associated with the UE is detected.

### BRIEF DESCRIPTION OF THE DRAWINGS

The teachings herein can be readily understood by considering the following detailed description in conjunction with the accompanying drawings, in which:

FIG. 1 depicts a high-level block diagram of a wireless communication system;

FIG. 2 depicts one embodiment of network-side handling of the ISR status of a UE when an exemplary method for deactivating a final context of the UE is performed;

FIG. 3 depicts one embodiment of network-side handling of the ISR status of a UE when an exemplary method for deactivating a non-final context of the UE is performed;

FIG. 4 depicts one embodiment of network-side handling of the ISR status of a UE when an exemplary method for modifying a context of the UE is performed;

FIG. 5 depicts one embodiment of network-side handling of the ISR status of a UE when an exemplary method for switching the UE between Radio Access Technologies is performed;

FIG. 6 depicts one embodiment of a method for handling of the ISR status of a UE at a network node in response to a condition associated with the UE; and

FIG. 7 depicts a high-level block diagram of a computer suitable for use in performing functions described herein.

To facilitate understanding, identical reference numerals have been used, where possible, to designate identical elements that are common to the figures.

### DETAILED DESCRIPTION

In general, a network-side Idle-State Signaling Reduction (ISR) handling capability is depicted and described herein, although various other capabilities also may be presented herein.

In at least some embodiments, the network-side ISR control capability supports network-side ISR handling under various conditions. The network-side ISR handling may be provided by supporting an ISR status for a UE on a network node and controlling modification of the ISR status for the UE on the network node under various conditions. The control over modification of the ISR status for the UE on the network node may include preventing a change of the state of the ISR status for the UE on the network node (i.e., maintaining the state of the ISR status for the UE on the network node in its current state) or effecting a change of the state of the ISR status for the UE on the network node (i.e., switching the state of the ISR status for the UE on the network node from its current state to a new state). The conditions may include a context deactivation event, a context modification event, an access network switching event, or the like. The states of the ISR status for the UE on the network node may include “ACTIVATED” (indicative that the ISR feature is active for the UE on the network node) and “DEACTIVATED” (indicative that the ISR feature is not active for the UE on the network node).

It is noted that, although primarly depicted and described herein within the context of supporting network-side ISR handling in a communication system having specific types of wireless communication networks, network-side ISR handling may be supported in any communication system having any suitable types of wireless communication networks in which ISR (or an ISR-like feature) is used.

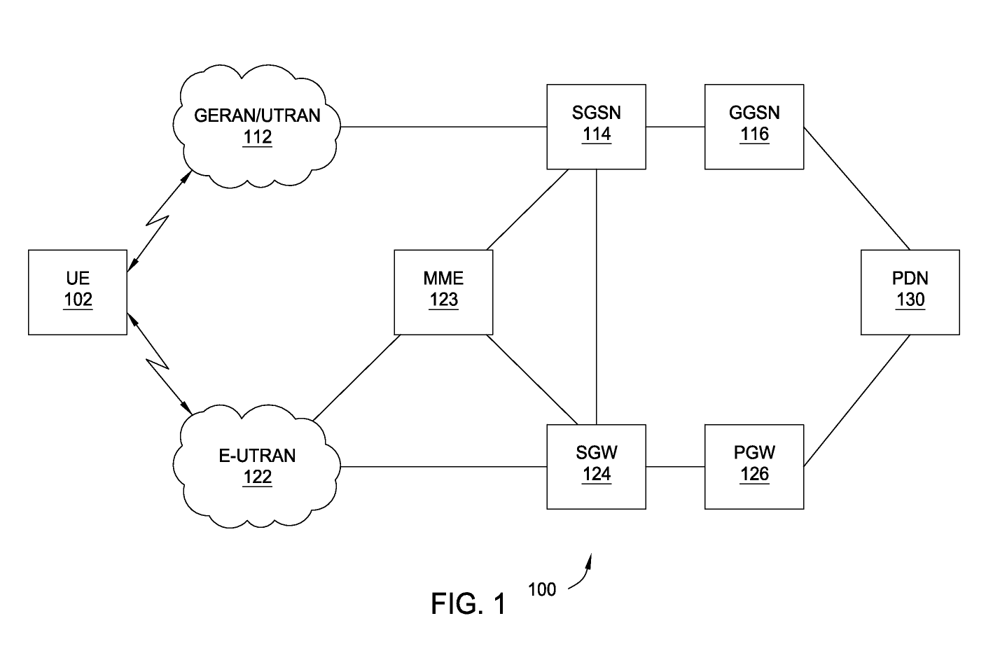

FIG. 1 depicts a high-level block diagram of a wireless communication system.

The wireless communication system 100 includes a User Equipment (UE) 102, a UMTS Terrestrial Radio Access Network (UTRAN)/Global System for Mobile Communications (GSM) EDGE Radio Access Network (GERAN) 112, a Serving General Packet Radio Service (GPRS) Support Node (SGSN) 114, a Gateway GPRS Support Node (GGSN) 116, an Evolved-UTRAN (E-UTRAN) 122, a Mobility Management Entity (MME) 123, a Serving Gateway (SGW) 124, a Packet Data Network (PDN) Gateway (PGW) 126, and a Packet Data Network (PDN) 130.

The UE 102 is a wireless device configured to access PDN 130 via two or more types of wireless access networks. As depicted in FIG. 1, UE 102 is configured to access PDN 130 via GERAN/UTRAN 112 (e.g., via a Base Transceiver Station (BTS) of a GERAN, via a NodeB of a UTRAN, or the like, where such network elements are omitted for purposes of clarity) and via E-UTRAN 122 (e.g., via an eNodeB, where this network element is omitted for purposes of clarity). For example, UE 102 may be a cellular phone, a smart phone, a tablet computer, a laptop computer, or the like.

The GERAN/UTRAN 112, SGSN 114, and GGSN 116 support a communication path (which may support multiple Packet Data Protocol (PDP) contexts) between the UE 102 and the PDN 130. As depicted in FIG. 1, the GERAN/UTRAN 112 is communicatively connected to SGSN 114, the SGSN 114 is communicatively connected to the GGSN 116, and the GGSN 116 is communicatively connected to the PDN 130. The typical operation of GERAN/UTRAN 112, SGSN 114, and GGSN 116 will be understood by one skilled in the art. The combination of the GERAN portion of GERAN/UTRAN 112, SGSN 114, and GGSN 116 may be understood to represent a Second Generation (2G) wireless communication network. Similarly, the combination of the UTRAN portion of GERAN/UTRAN 112, SGSN 114, and GGSN 116 may be understood to represent a Third Generation (3G) wireless communication network. In other words, GERAN/UTRAN 112 may be considered to represent availability of a 2G wireless communication network having a GERAN access network or a 3G wireless communication network having a UTRAN access network (or some hybrid combination thereof).

The E-UTRAN 122, MME 123, SGW 124, and PGW 126 support a communication path (which may support multiple Evolved Packet System (EPS) Mobility Management (EMM) contexts) between UE 102 and PDN 130. As depicted in FIG. 1, the E-UTRAN 122 is communicatively connected to the SGW 124, the SGW 124 is communicatively connected to the PGW 126, and the PGW 116 is communicatively connected to the PDN 130. Additionally, as depicted in FIG. 1, the MME 123 is communicatively connected to the E-UTRAN 122 and the SGW 124. The typical operation of E-UTRAN 122, MME 123, SGW 124, and PGW 126 will be understood by one skilled in the art. The combination of E-UTRAN 122, MME 123, SGW 124, and PGW 126 may be understood to represent a Fourth Generation (4G) wireless communication network.

The wireless communication system 100 supports communication between elements of the 2G/3G wireless network and the 4G wireless network. Namely, the SGSN 114 is communicatively connected to both MME 123 and SGW 124.

The PDN 130 may be any suitable type of packet data network which may be accessible via GGSN 116 and PGW 126 (e.g., the Internet, one or more private packet networks, or the like, as well as various combinations thereof).

The wireless communication system 100 supports Idle-State Signaling Reduction (ISR) in order to reduce the frequency of Tracking Area Update (TAU)/Routing Area Update (RAU) procedures caused when UE 102 (or any other UE) reselects between GERAN/UTRAN 112 (for 2G/3G wireless service) and E-UTRAN 122 (for 4G wireless service). ISR addresses this issue by allowing dual registration by UE 102 on both the GERAN/UTRAN 112 and the E-UTRAN 122, thereby allowing UE 102, while in an idle state, to reselect between GERAN/UTRAN 112 and E-UTRAN 122 without performing TAU or RAU procedures. ISR may be inactive for UE 102 or active for UE 102. When the ISR feature is inactive for UE 102, the UE 102 is only registered with one or the other of SGSN 114 (for access via the GERAN/UTRAN 112) and MME 123 (for access via the E-UTRAN 122). When the ISR feature is active for UE 102, the UE 102 is registered with both SGSN 114 and MME 123 (both of which have a control connection with SGW 124), and active contexts of the UE 102 (e.g., PDP contexts and/or EMM contexts) are accessible to both GERAN/UTRAN 112 and E-UTRAN 122 such that the contexts may be modified or deactivated from GERAN/UTRAN 112 or E-UTRAN 122.

The wireless communication system 100 is configured to support network-side handling of ISR status for UE 102.

The ISR status for UE 102 may be maintained on one or more network nodes of wireless communication system 100. In one embodiment, for example, the ISR status for UE 102 may be maintained on each of SGSN 114, MME 123, and SGW 124 (e.g., via respective ISR status parameters maintained for UE 102 on each of SGSN 114, MME 123, and SGW 124).

The ISR status for UE 102 may be supported by a network node using an ISR status parameter associated with the UE 102 on the network node. The ISR status parameter for UE 102 on a network node may support a first value indicative that ISR is active for the UE 102 on the network node (e.g., a value of ACTIVATED or any other value suitable for indicating that the ISR is active for UE 102) and a second value indicative that ISR is inactive for the UE 102 on the network node (e.g., a value of DEACTIVATED or any other value suitable for indicating that the ISR is not active for UE 102).

In one embodiment, a network node supporting an ISR status parameter for the UE 102 may be configured to switch the value of the ISR status parameter for the UE 102 (e.g., from DEACTIVATED to ACTIVATED or from ACTIVATED to DEACTIVATED) in response to one or more conditions.

For example, the ISR status parameter for the UE 102 may be changed from DEACTIVATED to ACTIVATED on a network node when the ISR feature is activated for the UE 102 on the UE 102. UE 102 may attach with MME 123 (and may be registered with MME 123 at a Home Subscriber Server (HSS)). The UE 102 then roams out of the Tracking Area (TA) of the MME 123 and sends a Routing Area Update (RAU) message to SGSN 114. The SGSN 114 forwards a Context Request message to the MME 123, receives a Context Response (ISR Capability) message from the MME 123, and sends a Context Acknowledgement message to the MME 123. The UE 102 is registered with SGSN 114 at the HSS. The SGSN 114 changes the ISR status parameter for UE 102 from DEACTIVATED to ACTIVATED in response to receiving an ISR supported indication in the Context Response message from the MME 123. The MME 123 changes the ISR status parameter for UE 102 from DEACTIVATED to ACTIVATED in response to the ISR Activated indication in the Context Acknowledgement message from SGSN 114. The SGSN 114 sends an RAU Accept message to UE 102. The UE 102 changes its ISR status parameter from DEACTIVATED to ACTIVATED in response to the ISR Activated indication in the RAU Accept message from SGSN 114.

For example, the ISR status parameter for the UE 102 may be changed from ACTIVATED to DEACTIVATED on a network node when the ISR feature becomes deactivated after UE 102 (in network mode of operation I) roams to a new RA and initiates a combined RA/Location Area (LA) update. The UE 102 sends the RA/LA update to SGSN 114. The SGSN 114 changes the ISR status parameter for the UE 102 from ACTIVATED to DEACTIVATED in response to the combined RA/LA update, forwards a Context Request message to the MME 123, receives a Context Response (ISR Capability) message from the MME 123, send a Context Acknowledgement message (without an ISR Activated indication) to the MME 123, and sends an RAU Accept message (without an ISR Activated indication) to UE 102. The MME 123 changes the ISR status parameter for UE 102 from ACTIVATED to DEACTIVATED in response to the Context Acknowledgement message from SGSN 114. The UE 102 changes its ISR status parameter from ACTIVATED to DEACTIVATED in response to the RAU Accept message from SGSN 114.

It is noted that the foregoing examples are merely a few examples of situations in which a network node supporting an ISR status parameter for UE 102 may be configured to switch the value of the ISR status parameter for the UE 102.

In one embodiment, a network node supporting an ISR status parameter for UE 102 may be configured to maintain a value of the ISR status parameter in response to one or more conditions. In this embodiment, maintaining the value of the ISR status parameter in response to a condition may be considered to be preventing a change of the ISR status parameter from a current value to a new value when the condition is detected.

In one embodiment, a network node supporting an ISR status parameter for UE 102 is configured to maintain the ISR status for UE 102 in an active state (e.g., by keeping the value the ISR status parameter for UE 102 set as ACTIVATED, rather than changing the value the ISR status parameter for UE 102 from ACTIVATED to DEACTIVATED) in response to detecting a condition. The detected condition may include deactivation of a context of the UE 102 that is not the last context of the UE 102, deactivation of a context of the UE 102 that is the last context of the UE 102, modification of a context of the UE 102, a switch of the UE 102 between Radio Access Technologies (e.g., from GERAN/UTRAN 112 to E-UTRAN 122 or from E-UTRAN 122 to GERAN/UTRAN 112). The contexts may include PDP contexts (associated with GERAN/UTRAN 112) and/or EMM contexts (associated with E-UTRAN 122), or the like.

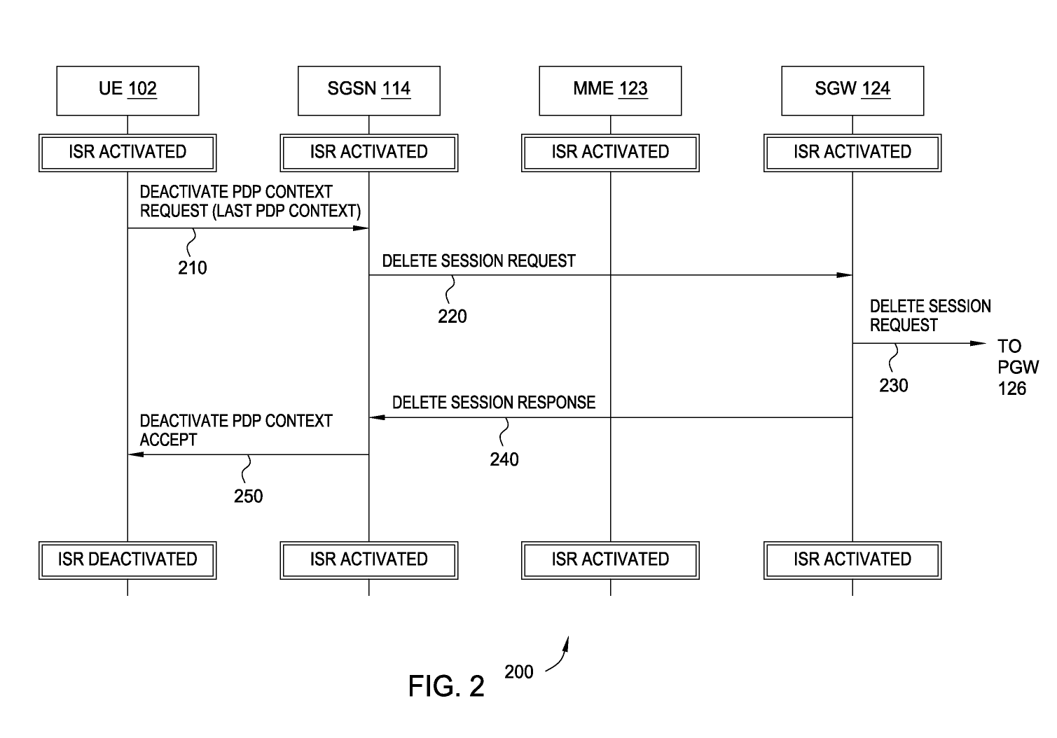

The operation of network nodes of wireless communication system 100 in maintaining the ISR status for UE 102 in an active state in response to such conditions is depicted and described herein with respect to FIGS. 2-5.

FIG. 2 depicts one embodiment of network-side handling of the ISR status of a UE when an exemplary method for deactivating a final context of the UE is performed.

As depicted in FIG. 2, method 200 involves UE 102 and certain network nodes (illustratively, SGSN 114, MME 123, and SGW 124). The UE 102, SGSN 114, MME 123, and SGW 124 each maintain respective ISR status parameters for UE 102, where the values of the ISR status parameters are indicative as to whether or not ISR is active for UE 102 on the UE 102, SGSN 114, MME 123, and SGW 124, respectively.

As depicted in FIG. 2, prior to the start of method 200, ISR is active for UE 102 on UE 102, as well as on SGSN 114, MME 123, and SGW 124. This is illustrated via the “ISR ACTIVATED” boxes depicted directly below the boxes representing UE 102, SGSN 114, MME 123, and SGW 124, respectively.

As depicted in FIG. 2, the method 200 for deactivating the final context of UE 102 includes five steps. It is noted that, although primarily depicted and described herein as being performed serially, the steps of method 200 may be performed contemporaneously and/or in a different order than presented in FIG. 2.

At step 210, a Deactivate PDP Context Request message is sent from UE 102 to SGSN 114. In this case, UE 102 is requesting deactivation of its final context.

At step 220, a Delete Session Request message is sent from SGSN 114 to SGW 124. The SGSN 114 does not include the “ISR DEACTIVATION” parameter in the Delete Session Request message that is sent to the SGW 124 and, as a result, ISR remains active for UE 102 on SGW 124.

At step 230, SGW 124 forwards the Delete Session Request message to PGW 126 (omitted for purposes of clarity). At step 240, SGW 124 sends a Delete Session Response message to SGSN 114. The SGW 124 does not send a Release Bearer Request message to MME 123 upon deactivation of the final PDP context in GERAN/UTRAN 112 and, as a result, ISR remains active for UE 102 on MME 123.

At step 250, SGSN 114 sends a Deactivate PDP Context Accept message to UE 102.

As a result of method 200, bearer resources in SGW 124 and PGW 126 are released, but the signaling resources in SGSN 114 and MME 123 are not released.

As depicted in FIG. 2, after completion of method 200, ISR is not active for UE 102 on UE 102, but remains active for UE 102 on each of SGSN 114, MME 123, and SGW 124. This is illustrated via the “ISR DEACTIVATED” box associated with UE 102 and the “ISR ACTIVATED” boxes associated with SGSN 114, MME 123, and SGW 124, respectively (depicted at the bottom of FIG. 2).

Thus, FIG. 2 illustrates the manner in which network-side handling of the ISR status of UE 102 ensures that ISR remains activated on the network nodes for UE 102 when a final context of UE 102 is deactivated.

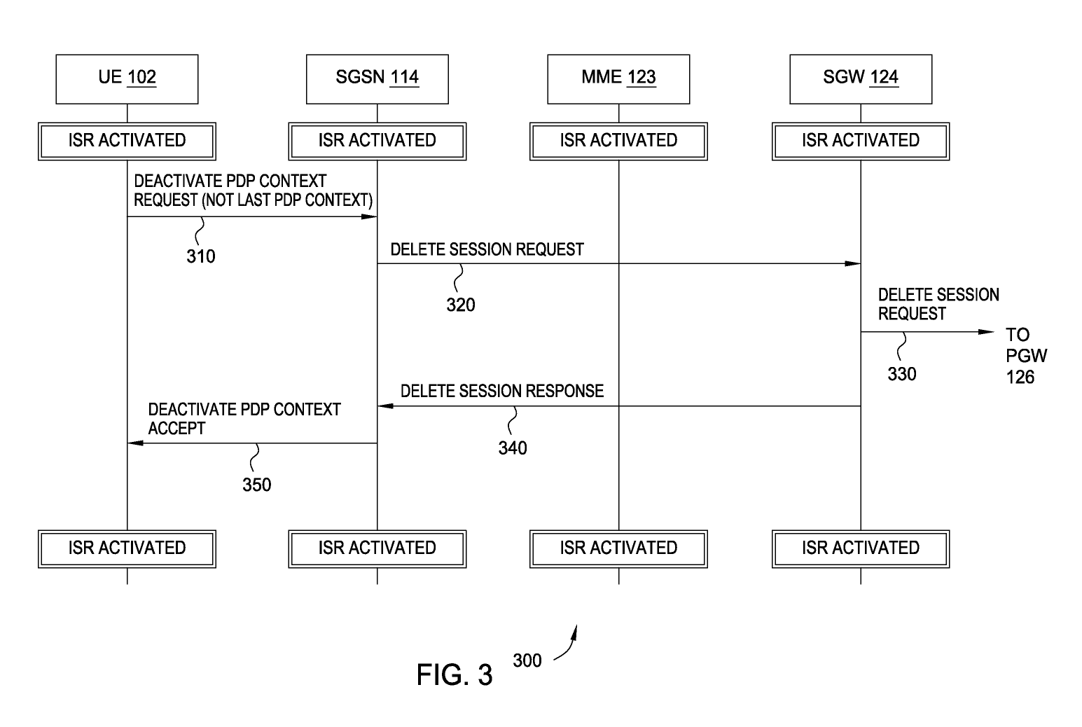

FIG. 3 depicts one embodiment of network-side handling of the ISR status of a UE when an exemplary method for deactivating a non-final context of the UE is performed.

FIG. 3 is identical to FIG. 2 (including steps 310, 320, 330, 340, and 350 of method 300 of FIG. 3 being identical to steps 210, 220, 230, 240, and 250 of method 200 of FIG. 2, respectively) with the exception that the ISR status of UE 102 is not deactivated on UE 102 since at least one context remains active on the UE 102. Thus, the operation of method 300 of FIG. 3 may be better understood by way of reference to FIG. 2.

As depicted in FIG. 3, after the completion of method 300, ISR remains active for UE 102 on UE 102, SGSN 114, MME 123, and SGW 124. This is illustrated via the “ISR ACTIVATED” boxes associated with UE 102, SGSN 114, MME 123, and SGW 124, respectively.

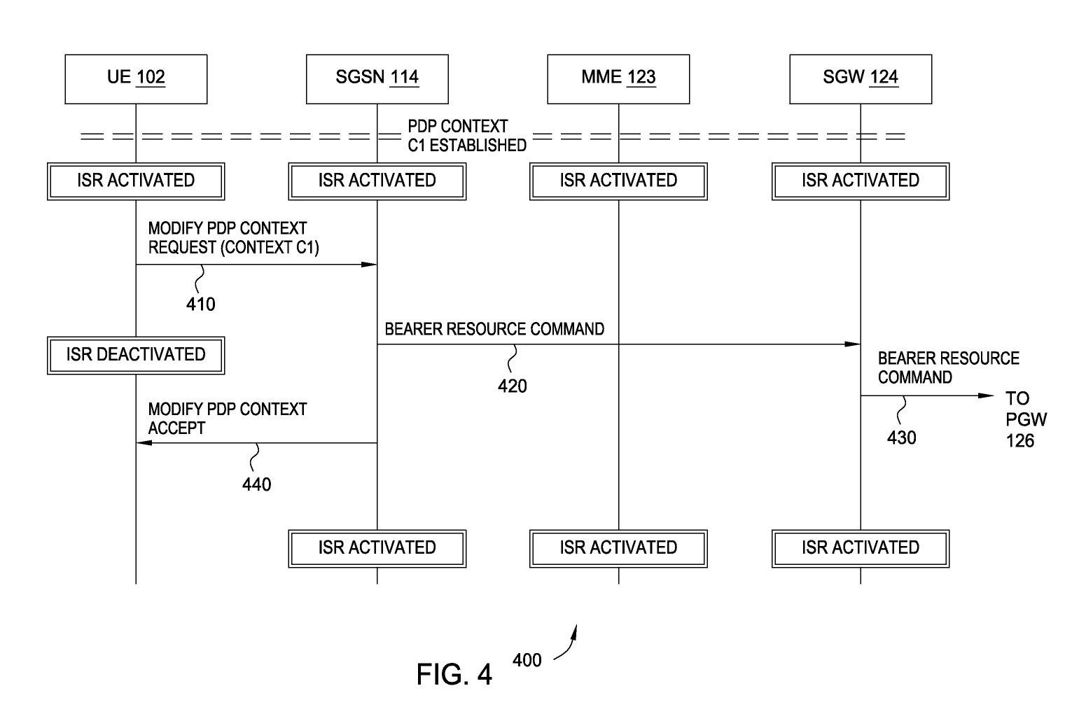

FIG. 4 depicts one embodiment of network-side handling of the ISR status of a UE when an exemplary method for modifying a context of the UE is performed.

As depicted in FIG. 4, method 400 involves UE 102 and certain network nodes (illustratively, SGSN 114, MME 123, and SGW 124). The UE 102, SGSN 114, MME 123, and SGW 124 each maintain respective ISR status parameters for UE 102, where the values of the ISR status parameters are indicative as to whether or not ISR is active for UE 102 on the UE 102, SGSN 114, MME 123, and SGW 124, respectively.

As depicted in FIG. 4, prior to the start of method 400, a PDP context is established for UE 102 and then ISR is activated for the UE 102 after the PDP context has been established for UE 102. The activation of ISR for UE 102 is illustrated via the respective “ISR ACTIVATED” boxes depicted below the boxes representing UE 102, SGSN 114, MME 123, and SGW 124 (but prior to the steps of method 400).

As depicted in FIG. 4, the method 400 for modifying the PDP context of UE 102 includes four steps. It is noted that, although primarily depicted and described herein as being performed serially, the steps of method 400 may be performed contemporaneously and/or in a different order than presented in FIG. 4.

At step 410, a Modify PDP Context Request message is sent from UE 102 to SGSN 114. In this case, UE 102 is requesting modification of the PDP context established for UE 102 prior to activation of ISR for UE 102. As depicted in FIG. 4, this causes ISR for UE 102 to be deactivated on UE 102 (as illustrated via the “ISR DEACTIVATED” box associated with UE 102 after the Modify PDP Context Request message is sent from UE 102 to SGSN 114).

At step 420, a Bearer Resource Command message is sent from SGSN 114 to SGW 124. At step 430, SGW 124 forwards the Bearer Resource Command message to PGW 126 (omitted for purposes of clarity).

At step 440, SGSN 114 sends a Modify PDP Context Accept message to UE 102.

It is noted that the de-synchronization of EPS bearers between the UE 102 and the network will be re-synchronized when the UE 102 accesses E-UTRAN 122 (e.g., at a Service Request due to the rejection of the Radio Bearer setup by the UE 102).

As depicted in FIG. 4, after completion of method 400, ISR is not active for UE 102 on UE 102, but remains active for UE 102 on each of SGSN 114, MME 123, and SGW 124. This is illustrated via the “ISR DEACTIVATED” box associated with UE 102 and the “ISR ACTIVATED” boxes associated with SGSN 114, MME 123, and SGW 124 (after the steps of method 400), respectively.

Thus, FIG. 4 illustrates the manner in which network-side handling of the ISR status of UE 102 ensures that ISR remains activated on the network nodes for UE 102 when a context of UE 102 (that was established prior to activation of ISR for UE 102) is modified.

It is noted that, although method 400 is primarily depicted and described with respect to the case in which the context of UE 102 is a PDP context, method 400 also may be used for the case in which the context of UE 102 is an EMM context. In this case, UE 102 sends an Update Bearer Request message to MME 123 (to request modification of an EMM context established for UE 102 prior to activation of ISR for UE 102). This causes ISR for UE 102 to be deactivated on UE 102 (similar to the case of PDP context modification). In this case, a Bearer Resource Command message is sent from MME 123 to SGW 124, and SGW 124 forwards the Bearer Resource Command message to PGW 126. In this case, MME 123 sends an Update Bearer Response message to UE 102. It will be appreciated that this flow for modification of an EMM context is similar to the flow depicted in FIG. 4 for modification of a PDP context (with functions performed by SGSN 114 for the PDP context being performed by MME 123 for the EMM context). In this case, ISR remains active for UE 102 on each of SGSN 114, MME 123, and SGW 124.

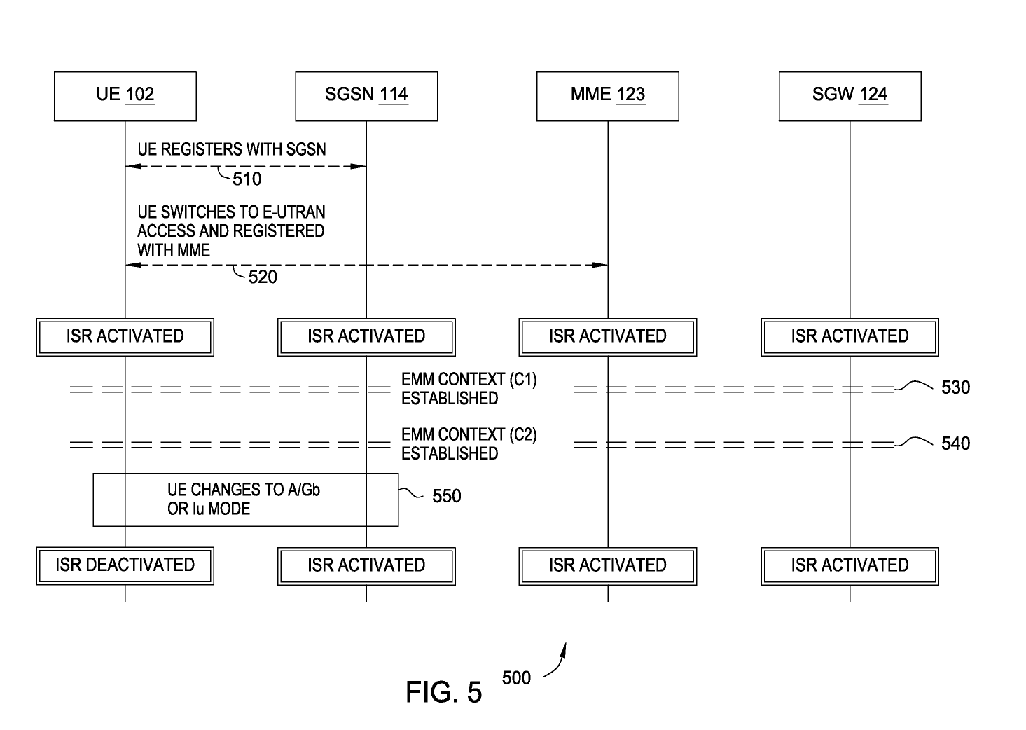

FIG. 5 depicts one embodiment of network-side handling of the ISR status of a UE when an exemplary method for switching the UE between Radio Access Technologies is performed.

As depicted in FIG. 5, method 500 depicts a case in which UE 102 switches from E-UTRAN access to GERAN/UTRAN access.

As depicted in FIG. 5, method 500 involves UE 102 and certain network nodes (illustratively, SGSN 114, MME 123, and SGW 124). The UE 102, SGSN 114, MME 123, and SGW 124 each maintain respective ISR status parameters for UE 102, where the values of the ISR status parameters are indicative as to whether or not ISR is active for UE 102 on the UE 102, SGSN 114, MME 123, and SGW 124, respectively.

As depicted in FIG. 5, the method 500 in which UE 102 switches from E-UTRAN access to GERAN/UTRAN access includes five steps. It is noted that, although primarily depicted and described herein as being performed serially, the steps of method 500 may be performed contemporaneously and/or in a different order than presented in FIG. 5.

At step 510, UE 102 accesses GERAN/UTRAN 112 and registers with SGSN 114 via the GERAN/UTRAN 112. At step 520, UE 102 switches from access via GERAN/UTRAN 112 to access via E-UTRAN 122, and registers with MME 123 via E-UTRAN 122.

As depicted in FIG. 5, following steps 510 and 520, ISR is activated for UE 102 and, as a result, ISR is active for UE 102 on UE 102 as well as on SGSN 114, MME 123, and SGW 124. This is illustrated via the “ISR ACTIVATED” boxes depicted below the boxes representing UE 102, SGSN 114, MME 123, and SGW 124, respectively (depicted between steps 520 and 530 of method 500).

At step 530, a first EMM context (denoted as EMM Context C1) is established for UE 102. At step 540, a second EMM context (denoted as EMM Context C2) is established for UE 102. It is noted that fewer or more EMM contexts may be established.

At step 550, UE 102 switches from access via E-UTRAN 122 to access via GERAN/UTRAN 112 (e.g., to A/Gb mode for access via a GERAN or to Iu mode for access via a UTRAN).

As depicted in FIG. 5, after completion of method 500, ISR is not active for UE 102 on UE 102, but remains active for UE 102 on each of SGSN 114, MME 123, and SGW 124. This is illustrated via the “ISR DEACTIVATED” box associated with UE 102 and the “ISR ACTIVATED” boxes associated with SGSN 114, MME 123, and SGW 124(after the steps of method 500), respectively.

Thus, FIG. 5 illustrates the manner in which network-side handling of the ISR status of UE 102 ensures that ISR remains activated on the network nodes for UE 102 when UE 102 switches between Radio Access Technologies (RATs).

It is noted that, although method 500 is primarily depicted and described with respect to the case in which UE 102 switches from E-UTRAN access to GERAN/UTRAN access, method 500 also could be adapted to represent a case in which UE 102 switches from GERAN/UTRAN access to E-UTRAN access. In this case, ISR remains active for UE 102 on each of SGSN 114, MME 123, and SGW 124.

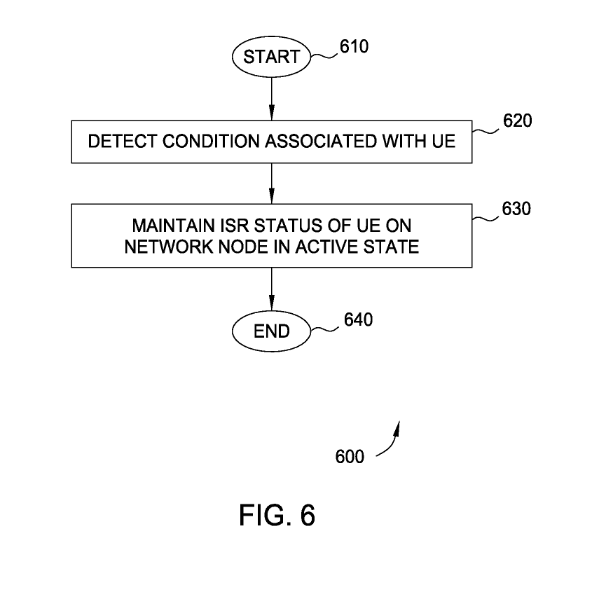

FIG. 6 depicts one embodiment of a method for handling of the ISR status of a UE at a network node in response to a condition associated with the UE.

At step 610, method 600 begins.

At step 620, a condition associated with the UE is detected. The condition is detected by the network node (e.g., directly, indirectly via receipt of a message(s) from one or more other nodes, or the like). The condition may include deactivation of a context of the UE, modification of a context of the UE, a switch by the UE between access modes (e.g., between RATs), or the like.

At step 630, an ISR status of the UE on the network node is maintained in the active state when the condition associated with the UE is detected. In other words, despite detection of a condition by the network node, the ISR status of the UE on the network node is not changed from its current value to a new value (e.g., from ACTIVATED to DEACTIVATED).

At step 640, method 600 ends.

In one embodiment, a network node supporting an ISR status parameter for UE 102 is configured to maintain the ISR status for UE 102 in an active state (e.g., by keeping the value the ISR status parameter for UE 102 set as ACTIVATED, rather than changing the value the ISR status parameter for UE 102 from ACTIVATED to DEACTIVATED) until deactivation of ISR for the UE 102 is detected (e.g., the ISR status of UE 102 remains in a persistent active state until deactivation of ISR for the UE 102 is detected).

As described herein, although primarly depicted and described herein within the context of supporting network-side ISR handling in specific types of communication networks, network-side ISR handling may be supported in any suitable types of wireless networks in which ISR (or an ISR-like feature) is used. Accordingly, references herein that are specific to 2G, 3G, and 4G wireless communication networks may be read more generally as covering similar elements and features of other types of wireless communication networks. For example, references herein that are specific to E-UTRAN and UTRAN/GERAN networks (e.g., specific names used for elements, functions, messages, parameters, or the like) may be read more generally so as to cover other types of wireless communication networks (e.g., where different names may be used for similar elements, functions, messages, parameters, or the like). For example, references herein to UEs may be read more generally as being wireless user devices or wireless terminals. For example, references herein to specific network nodes (e.g., SGSN 114, GGSN 116, MME 123, SGW 124, PGW 126, and PDN 130) may be read more generally as covering network nodes of other types of wireless communication networks which support identical or similar functions in those other types of wireless communication networks. For example, references herein to PDP and EMM contexts may be read more generally as contexts. For example, references herein to specific messages (e.g., the Deactivate PDP Context Request/Accept messages, the Delete Session Request/Response messages, the Modify PDP Context Request/Accept messages, Bearer Resource Command messages, and the like) may be read more generally (e.g., as deactivate context request/accept messages, delete session request/response messages, the modify context request/accept messages, bearer resource command messages, and the like, respectively). It is noted that those skilled in the art and informed by the teachings provided herein will recognize other such generalizations supporting use of embodiments of the network-side ISR handling capability in other types of wireless communication networks.

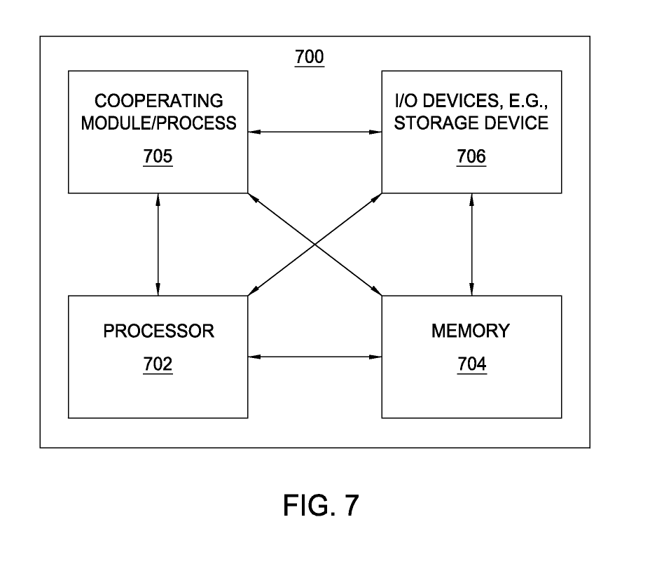

FIG. 7 depicts a high-level block diagram of a computer suitable for use in performing functions described herein.

The computer 700 includes a processor element 702 (e.g., a central processing unit (CPU) and/or other suitable processor(s)) and a memory 704 (e.g., random access memory (RAM), read only memory (ROM), or the like). The processor element 702 and the memory 704 are communicatively connected. The memory 704 may have stored thereon instructions which, when executed by the processor element 702, enable or cause the processor element 702 to perform various functions depicted and described herein. Although primarily depicted and described with respect to a single processor element 702 and a single memory 704, it is noted that any suitable numbers of processor elements 702 and memories 704 may be used to provide various functions depicted and described herein.

The computer 700 also may include a cooperating module/process 705. The cooperating process 705 can be loaded into memory 704 and executed by the processor 702 to implement functions as discussed herein and, thus, cooperating process 705 (including associated data structures) can be stored on a computer readable storage medium, e.g., RAM memory, magnetic or optical drive or diskette, or the like.

The computer 700 also may include various input/output devices 706 (e.g., a user input device (such as a keyboard, a keypad, a mouse, or the like), a user output device (such as a display, a speaker, or the like), an input port, an output port, a receiver, a transmitter, and storage devices (e.g., a tape drive, a floppy drive, a hard disk drive, a compact disk drive, or the like)).

It will be appreciated that computer 700 depicted in FIG. 7 provides a general architecture and functionality suitable for implementing functional elements described herein and/or portions of functional elements described herein. For example, the computer 700 provides a general architecture and functionality suitable for implementing one or more of a UE 102, a portion of UE 102, an element of GERAN/UTRAN 112, a portion of an element of GERAN/UTRAN 112, SGSN 114, a portion of SGSN 114, GGSN 116, a portion of GGSN 116, an element of E-UTRAN 122, a portion of an element of E-UTRAN 122, MME 123, a portion of MME 123, SGW 124, a portion of SGW 124, PGW 126, a portion of PGW 126, and so forth.

It will be appreciated that the functions depicted and described herein may be implemented in software (e.g., via implementation of software on one or more processors, for executing on a general purpose computer (e.g., via execution by one or more processors) so as to implement a special purpose computer, or the like) and/or may be implemented in hardware (e.g., using a general purpose computer, one or more application specific integrated circuits (ASIC), and/or any other hardware equivalents).

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. An apparatus, comprising:
a processor and a memory communicatively connected to the processor, the processor configured to maintain an Idle-State Signaling Reduction (ISR) status for a User Equipment (UE) on a network node in an active state when a condition associated with the UE is detected.

2. The apparatus of claim 1, wherein the condition comprises one of a deactivation of a context of the UE, a modification of a context of the UE, and a switching of an access mode of the UE.

3. The apparatus of claim 2, wherein the context of the UE is a Packet Data Protocol (PDP) context or an Evolved Packet System (EPS) Mobility Management (EMM) context.

4. The apparatus of claim 2, wherein the switching of the access mode of the UE comprises:
switching between:
Global System for Mobile Communications (GSM) EDGE Radio Access Network (GERAN) access or Universal Mobile Telecommunications System (UMTS) Terrestrial Radio Access Network (UTRAN) access; and
Evolved-Terrestrial Radio Access Network (E-UTRAN) access.

5. The apparatus of claim 1, wherein the network node comprises a Serving General Packet Radio Service (GPRS) Support Node (SGSN) capability, a Mobility Management Entity (MME) capability, a combined SGSN/MME capability, or a Serving Gateway (SGW) capability.

6. The apparatus of claim 1, wherein the network node is a Serving General Packet Radio Service (GPRS) Support Node (SGSN), wherein the condition comprises deactivation of a context of the UE, wherein the processor is configured to:
receive a request of the UE to deactivate the context of the UE; and
generate a delete session request message without including an “ISR Deactivation” parameter in the delete session request message.

7. The apparatus of claim 6, wherein the processor is configured to propagate the delete session request message toward a Serving Gateway (SGW).

8. The apparatus of claim 7, wherein the processor is configured to receive a delete session response message from the SGW.

9. The apparatus of claim 7, wherein the processor is configured to:
generate a response to the request of the UE to deactivate the context of the UE; and
propagate the response toward the UE.

10. The apparatus of claim 1, wherein the network node is a Serving Gateway (SGW), wherein the condition comprises deactivation of a context of the UE, wherein the processor is configured to:
receive a delete session request message from a Serving General Packet Radio Service (GPRS) Support Node (SGSN); and
maintain the ISR status for the UE on the network node in the active state in response to a determination that the delete session request message does not include an “ISR Deactivation” parameter.

11. The apparatus of claim 10, wherein the processor is configured to propagate a delete session response message toward the SGSN.

12. The apparatus of claim 10, wherein the processor is configured to propagate the delete session request message toward a Packet Data Network (PDN) Gateway (PGW).

13. The apparatus of claim 1, wherein the network node is a Serving General Packet Radio Service (GPRS) Support Node (SGSN) or a Mobility Management Entity (MME), wherein the condition comprises modification of a context of the UE, wherein the processor is configured to:
receive a request of the UE to modify the context of the UE; and
generate a bearer resource command message without including an “ISR Deactivation” parameter in the bearer resource command message.

14. The apparatus of claim 13, wherein the processor is configured to propagate the bearer resource command message toward a Serving Gateway (SGW).

15. The apparatus of claim 13, wherein the processor is configured to:
generate a response to the request of the UE to modify the context of the UE; and
propagate the response toward the UE.

16. The apparatus of claim 13, wherein the context of the UE was established prior to activation of ISR by the UE.

17. The apparatus of claim 1, wherein the network node is a Serving Gateway (SGW), wherein the condition comprises modification of a context of the UE, wherein the processor is configured to:
receive a bearer resource command message from a Serving General Packet Radio Service (GPRS) Support Node (SGSN) or a Mobility Management Entity (MME); and
maintain the ISR status for the UE on the network node in the active state in response to a determination that the bearer resource command message does not include an “ISR Deactivation” parameter.

18. The apparatus of claim 17, wherein the processor is configured to propagate the bearer resource command message toward a Packet Data Network (PDN) Gateway (PGW).

19. A network node, comprising:
a processor and a memory communicatively connected to the processor, the processor configured to maintain an Idle-State Signaling Reduction (ISR) status for a User Equipment (UE) on the network node in an active state in response to a condition associated with the UE.

20. A computer-readable storage medium storing instructions which, when executed by a computer, cause the computer to perform a method, the method comprising:
maintaining an Idle-State Signaling Reduction (ISR) status for a User Equipment (UE) on a network node in an active state when a condition associated with the UE is detected.

21. A method, comprising:
using a processor and a memory for maintaining an Idle-State Signaling Reduction (ISR) status for a User Equipment (UE) on a network node in an active state when a condition associated with the UE is detected.
